(19) United States
(12) Patent Application Publication
(10) Pub. No.: US 2025/0389683 A1
(43) Pub. Date: Dec. 25, 2025

(54) CONCENTRATION DETECTION METHOD AND CONCENTRATION DETECTION DEVICE

(71) Applicant: Primetals Technologies Japan, Ltd., Hiroshima-shi, Hiroshima (JP)

(72) Inventors: Ryusuke NAKATSUKA, Hiroshima-shi (JP); Kosei TSUJI, Hiroshima-shi (JP); Takashi NAKANO, Tokyo (JP); Yuki MAEHASHI, Tokyo (JP); Masashi YOSHIKAWA, Tokyo (JP)

(73) Assignee: Primetals Technologies Japan, Ltd., Hiroshima-shi, Hiroshima (JP)

(21) Appl. No.: 18/879,091

(22) PCT Filed: Sep. 21, 2022
(86) PCT No.: PCT/JP2022/035163

§ 371 Date: Dec. 26, 2024

(51) Int. Cl. G01N 27/06; C23G 1/08; G01N 9/00; G01N 27/416

(52) U.S. Cl. CPC G01N 27/06; G01N 9/00; G01N 27/4168; C23G 1/08

(57) ABSTRACT

A method for detecting concentrations of a Fe²⁺ ion and/or a Fe³⁺ ion contained in an acid solution used for pickling of a rolled material, wherein
a Fe²⁺ ion concentration and/or a Fe³⁺ ion concentration are determined based on
   relationship (1) of the Fe²⁺ ion concentration as a function of an electrical conductivity EC, a specific gravity d, and a hydrochloric acid concentration, of the acid solution,
   relationship (2) of the Fe³⁺ ion concentration as a function of the electrical conductivity EC, the specific gravity d, and the hydrochloric acid concentration, of the acid solution,
   relationship (3) of oxidation-reduction potential ORP as a function of the Fe²⁺ ion concentration, the Fe³⁺ ion concentration, and the hydrochloric acid concentration, of the acid solution, and
   the electrical conductivity EC, the specific gravity d, and the oxidation-reduction potential ORP, of the acid solution, measured during pickling.

### TECHNICAL FIELD

The present invention relates to the acid pickling of a metal material, particularly, a steel material.

### BACKGROUND ART

Acid pickling is a treatment of immersing a metal material in an acidic solution with hydrochloric acid, sulfuric acid or the like, and thereby washing and removing an oxide layer, rust and others attached to the surface. Examples of the metal material subjected to the acid pickling include a cold-rolled steel sheet, a hot-rolled steel sheet that is a rolled raw material of a cold-rolled steel sheet, and a hot-rolled steel sheet that is a final product. The acid pickling is sometimes performed by spraying the acidic solution, instead of the immersion in the acidic solution. In the acidic solution, components are adjusted such that a high acid pickling efficiency is obtained. However, when the acid pickling is continued, the composition of the acidic solution, particularly, the acid concentration changes with time, so that the effect of the acid pickling decreases. Hence, the adjustment of the acid concentration is performed in the process of the acid pickling.

For example, Patent Literature 1 discloses that the density, temperature and conductivity of an acidic solution that is used in acid pickling facility are continuously measured and a hydrochloric acid concentration and a ferric chloride concentration are determined when the acid concentration of the acidic solution is managed. More specifically, the hydrochloric acid concentration and the ferric chloride concentration, that is, Fe ion concentrations are derived, the results are continuously output, the hydrochloric acid concentration value and a target value are compared, and an additional amount of the acidic solution is determined such that the difference between them becomes zero.

Further, Patent Literature 2 mentions that the acid pickling power is kept at a constant power and a Fe³⁺ ion concentration is maintained at 1 g/liter to 300 g/liter. Therefore, Patent Literature 2 proposes that Fe²⁺ ions produced during the acid pickling are oxygenated and oxidized again and the oxidation-reduction potential that is measured between a platinum electrode provided in the acidic solution and an Ag/AgCl reference electrode is maintained at 0 to 800 mV.

### CITATION LIST

### Patent Literature

Patent Literature 1: JP 2000-313979 A
Patent Literature 2: JP 4186131 B2

### SUMMARY OF INVENTION

### Technical Problem

The concentration of the Fe ions, particularly, Fe³⁺ ions contained in the acidic solution when the acid pickling is being performed, influences the performance of the acid pickling.

However, Patent Literature 1 mentions the Fe ion concentration, but does not disclose specific concentrations of Fe²⁺ ions and Fe³⁺ ions, and it is not considered at all that there can be two valence states (Fe³⁺, Fe²⁺).

Further, Patent Literature 2 discloses that Fe²⁺ ions and Fe³⁺ ions are present in the acidic solution when the acid pickling is being performed, but does not disclose specific concentrations of the Fe²⁺ ions and Fe³⁺ ions. It is difficult to obtain appropriate concentrations of the Fe²⁺ ions and the Fe³⁺ ions, by the adjustment of only the oxidation-reduction potential as described in Patent Literature 2.

Hence, the present invention has an object to provide a detection method that makes it possible to quickly detect the concentrations of the Fe²⁺ ions and the Fe³⁺ ions that are actually contained in the acidic solution, particularly, the concentration of the Fe³⁺ ions, during the acid pickling.

### Solution to Problem

In a concentration detection method for one or both of Fe²⁺ ions and Fe³⁺ ions contained in an acidic solution for acid pickling of a rolled material in the present invention,
one or both of a Fe²⁺ ion concentration and a Fe³⁺ ion concentration are determined, based on
a relational expression (1) of the Fe²⁺ ion concentration that is a function of an electrical conductivity EC, a specific gravity d, and a hydrochloric acid concentration of the acidic solution,
a relational expression (2) of the Fe³⁺ ion concentration that is a function of the electrical conductivity EC, the specific gravity d, and the hydrochloric acid concentration of the acidic solution,
a relational expression (3) of an oxidation-reduction potential ORP that is a function of the Fe²⁺ ion concentration, the Fe³⁺ ion concentration, and the hydrochloric acid concentration of the acidic solution, and
the electrical conductivity EC, the specific gravity d, and the oxidation-reduction potential ORP of the acidic solution that are measured during the acid pickling.

In the concentration detection method in the present invention, the relational expression (3) of the oxidation-reduction potential ORP is preferably expressed as a logarithmic leaner combination of the Fe²⁺ ion concentration, the Fe³⁺ ion concentration, and the hydrochloric acid concentration.

The concentration detection method in the present invention preferably includes a first measurement step and a relational expression construction step.

In the first measurement step,
the electrical conductivity EC, the specific gravity d, the oxidation-reduction potential ORP, the Fe²⁺ ion concentration, and the Fe³⁺ ion concentration are measured, for each of a plurality of kinds of acidic solutions that contain the Fe²⁺ ions and the Fe³⁺ ions having unknown concentrations and that are different in the hydrochloric acid concentration.

In the relational expression construction step,
the relational expression (1) that predicts the Fe²⁺ ion concentration, from the electrical conductivity EC and the specific gravity d that are measured in the first measurement step, and the hydrochloric acid concentration that is known,
the relational expression (2) that predicts the Fe³⁺ ion concentration, from the electrical conductivity EC and the specific gravity d that are measured in the first measurement step, and the hydrochloric acid concentration that is known, and
the relational expression (3) that predicts the oxidation-reduction potential ORP, from the Fe²⁺ ion concentration and the Fe³⁺ ion concentration that are measured in the first measurement step, and the hydrochloric acid concentration that is known
are specified, by a multiple regression analysis.

The concentration detection method in the present invention preferably includes an acquisition step, a second measurement step, and a computation step, after the relational expression construction step.

In the acquisition step, the acidic solution during the acid pickling is acquired.

In the second measurement step, the electrical conductivity EC, the specific gravity d, and the oxidation-reduction potential ORP of the acquired acidic solution are measured.

In the computation step, the Fe²⁺ ion concentration and the Fe³⁺ ion concentration are determined, based on the electrical conductivity EC, the specific gravity d, and the oxidation-reduction potential ORP that are measured in the second measurement step, the relational expression (1), the relational expression (2), and the relational expression (3).

Preferably, in the relational expression construction step,
an objective variable of the relational expression (1) is the Fe²⁺ ion concentration, explanatory variables include the electrical conductivity EC and the specific gravity d that are measured in the first measurement step, and the hydrochloric acid concentration that is known, and respective coefficients of the explanatory variables are determined,
an objective variable of the relational expression (2) is the Fe³⁺ ion concentration, explanatory variables include the electrical conductivity EC and the specific gravity d that are measured in the first measurement step, and the hydrochloric acid concentration that is known, and respective coefficients of the explanatory variables are determined, and
an objective variable of the relational expression (3) is the oxidation-reduction potential ORP, explanatory variables include logarithms of the Fe²⁺ ion concentration and the Fe³⁺ ion concentration that are measured in the first measurement step, and a logarithm of the hydrochloric acid concentration that is known, and respective coefficients of the explanatory variables are determined.

The coefficients of the explanatory variables of the relational expression (3) in the relational expression construction step are preferably determined such that the hydrochloric acid concentration in the acid pickling tank at time of start of the acid pickling is included.

A concentration detection device for Fe²⁺ ions and Fe³⁺ ions contained in an acidic solution for acid pickling of a rolled material in the present invention includes:
an information acquisition part configured to acquire information relevant to measurement values relevant to an electrical conductivity meter, a specific gravity, and oxidation-reduction potential about the acidic solution; and
a computation part configured to determine one or both of a Fe²⁺ ion concentration and a Fe³⁺ ion concentration, based on the electrical conductivity, the specific gravity, and the oxidation-reduction potential that are acquired by the property acquisition part.

The concentration detection device in the present invention preferably includes a measurement part. The measurement part includes:
an electrical conductivity meter configured to measure the electrical conductivity of the acidic solution;
a specific gravity meter configured to measure the specific gravity of the acidic solution; and
an oxidation-reduction potentiometer configured to measure the oxidation-reduction potential of the acidic solution.

The computation part in the present invention preferably
determines one or both of the Fe²⁺ ion concentration and the Fe³⁺ ion concentration, based on
a relational expression (1) of the Fe²⁺ ion concentration that is a function of an electrical conductivity EC, a specific gravity d, and a hydrochloric acid concentration of the acidic solution,
a relational expression (2) of the Fe³⁺ ion concentration that is a function of the electrical conductivity EC, the specific gravity d, and the hydrochloric acid concentration of the acidic solution,
a relational expression (3) of an oxidation-reduction potential ORP that is a function of the Fe²⁺ ion concentration, the Fe³⁺ ion concentration, and the hydrochloric acid concentration of the acidic solution, and
the electrical conductivity EC, the specific gravity d, and the oxidation-reduction potential ORP of the acidic solution that are measured during the acid pickling.

### Advantageous Effect of Invention

According to the present invention, it is possible to quickly detect the concentrations of the Fe²⁺ ions and the Fe³⁺ ions that are actually contained in the acidic solution, particularly, the concentration of the Fe³⁺ ions, during the acid pickling.

### BRIEF DESCRIPTION OF DRAWINGS

FIG. 1 is a flowchart showing a procedure of a concentration detection method according to an embodiment.

FIG. 2 is a table showing actual measured values of detected concentrations of an acidic solution that are used for constructing relational expressions according to the embodiment.

FIG. 3 is a graph showing relations between calculated values obtained by substituting the actual measured values shown in the table in FIG. 2 into estimation equations as bases of the relational expressions and actual measured values, an upper stage being relevant to a hydrochloric acid concentration [H+], a lower stage being relevant to a Fe²⁺ ion concentration [Fe²⁺ ].

FIG. 4 shows a graph showing a relation between calculated values and actual measured values relevant to a Fe³⁺ ion concentration [Fe³⁺] at an upper stage, and shows a table showing standard deviations of various concentrations at a lower stage.

FIG. 5 is a diagram showing an example of acid pickling facility that can perform the concentration detection method according to the embodiment.

### DESCRIPTION OF EMBODIMENT

A concentration detection method and a concentration detection device for Fe²⁺ ions and Fe³⁺ ions according to an embodiment will be described below. When the distinction between Fe²⁺ ions and Fe³⁺ ions is not necessary, they are sometimes collectively referred to as Fe ions.

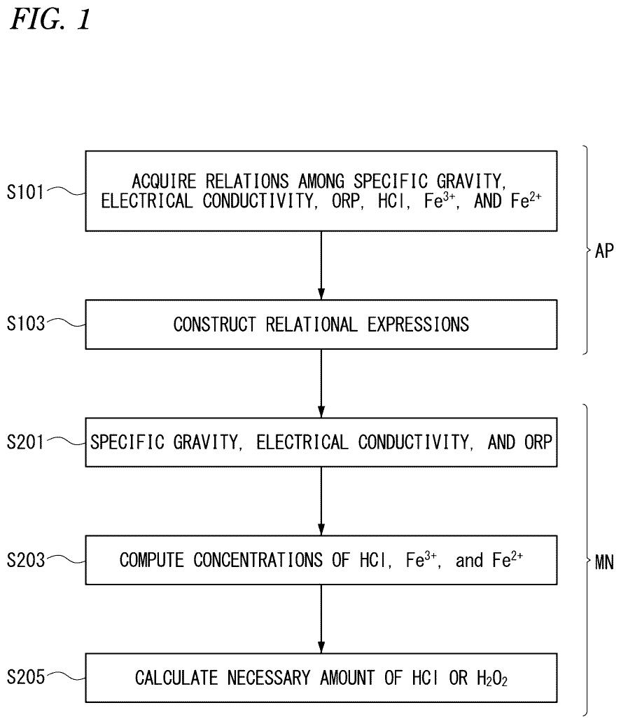

### [Concentration Detection Procedure: See FIG. 1]

In the embodiment, an acidic solution with which acid pickling is being performed is acquired, properties of the acidic solution are measured, and based on the measurement results, a Fe ion concentration is detected by computation. For this, relational expressions between the properties and the Fe ion concentration are constructed in advance. That is, in the embodiment, as shown in FIG. 1, two procedures: an advance preparation step AP of constructing the relational expressions and a monitoring step MN of determining the Fe ion concentration by computation are performed in sequence. The monitoring step MN makes it possible to calculate the amount of an additive agent to be added to the acidic solution for maintaining the performance of the acid pickling, based on the detected Fe ion. The acidic solution in the embodiment is intended to be an acidic solution in which a main component is hydrochloric acid.

In FIG. 1, the advance preparation step AP and the monitoring step MN are described so as to be sequentially performed, but the present invention is not limited to this. After the relational expressions are constructed by the advance preparation step AP, the monitoring step MN can be independently performed using the constructed relational expressions, without the advance preparation step AP.

### [Outline of Advance Preparation Step AP]

The advance preparation step AP includes a step (S101) of acquiring relations between properties of the acidic solution that are necessary for constructing the relational expressions and the Fe ion concentration, and a step (S103) of constructing the relational expressions based on the acquired relations. More specific contents will be described below in sequence.

### [Relation Acquisition Step (S101)]

For a Fe²⁺ ion concentration, a Fe³⁺ ion concentration, and an oxidation-reduction potential (ORP), estimation equations constituted by the following equations (1) to (3) are devised. For the estimation equations, it is assumed that the Fe²⁺ ion concentration ([Fe²⁺]) and the Fe³⁺ ion concentration ([Fe³⁺]) can be detected while the acid pickling is being performed and the detected results can be quickly reflected in the acid pickling that is being performed. In the embodiment, this is expressed such that the detected results can be reflected online, or can be handled online.

For example, [Fe²⁺] and [Fe³⁺] can be detected by a titrimetric analysis that is a quantitative analysis method for measuring the amount of a chemical substance using a chemical reaction. However, the titrimetric analysis requires a considerable time, and therefore, it cannot be said that the analysis result can be reflected online. Particularly, in the case of a titrimetric method, since processes such as the supplemental of a titrant, the sampling of a specimen, and dilution are necessary, and therefore, automatically obtaining the detection result places a heavy burden, including equipment requirements. Hence, in the embodiment, the estimation equations are devised assuming that the analysis result can be reflected online.

Accordingly, the respective estimation equations have, as elements, properties that can be quickly detected about the acidic solution with which the acid pickling is being performed, and express [Fe²⁺] and [Fe³⁺], which are unknown quantities, by the properties. [Fe²⁺] and [Fe³⁺] in the acidic solution are related also to the unknown concentration ([H⁺]) of hydrochloric acid (HCl) contained in the acidic solution. Accordingly, for obtaining solutions of the three unknown quantities: [Fe²⁺], [Fe³⁺], and [H⁺], the estimation equations (1) to (3) that are simultaneous equations with three variables are adopted.

An electrical conductivity (EC), a specific gravity (d), and an oxidation-reduction potential (ORP) are selected as properties that can be quickly detected about the acidic solution and that are relevant to [Fe²⁺], [Fe³⁺], and [H⁺], and the following equations (1) to (3) are adopted as the estimation equations. For the following estimation equations, a potential relation between Fe²⁺ and Fe³⁺ that is shown by equation (0) is assumed.

### <Estimation Equations>

$${Fe}^{3 +} + {e}^{-} = {Fe}^{2 +} \qquad Equation ( 0 )$$

$$[ {Fe}^{2 +} ] = A ⋆ EC + B ⋆ {EC}^{2} + C ⋆ d + D ⋆ {d}^{2} + E ⋆ [ {H}^{+} ] + F \qquad Equation ( 1 )$$

$$[ {Fe}^{3 +} ] = G ⋆ EC + H ⋆ {EC}^{2} + I * d + J ⋆ {d}^{2} + K ⋆ [ {H}^{+} ] + L \qquad Equation ( 2 )$$

$$ORP = M ⋆ Ln [ {Fe}^{2 +} ] + N ⋆ Ln [ {Fe}^{3 +} ] + O ⋆ Ln [ {H}^{+} ] + P \qquad Equation ( 3 )$$

EC: electrical conductivity (S/m), d: specific gravity (g/cm3)
ORP: oxidation-reduction potential (mV)
[Fe²⁺]: the concentration (mol/L) of Fe²⁺ ions
[Fe³⁺]: the concentration (mol/L) of Fe³⁺ ions
[H⁺]: the concentration (mol/L) of HCl
A to L: constant
M to P: variable depending on T-HCl (assumed as a quadratic function of T-HCl)

The hydrochloric acid (HCL) contained in the acidic solution before the use for the acid pickling is consumed by the acid pickling. However, some portion is not consumed, and remains in the form of hydrochloric acid, and this is sometimes referred to as free hydrochloric acid (HCl). The above-mentioned [H⁺] corresponds to this. When the acid pickling of steel is performed with an acidic solution mainly containing hydrochloric acid, the consumed hydrochloric acid appears in the forms of ferric chlorides (FeCl₂, FeCl₃) as compounds. The total of them is T-HCl (total hydrochloric acid).

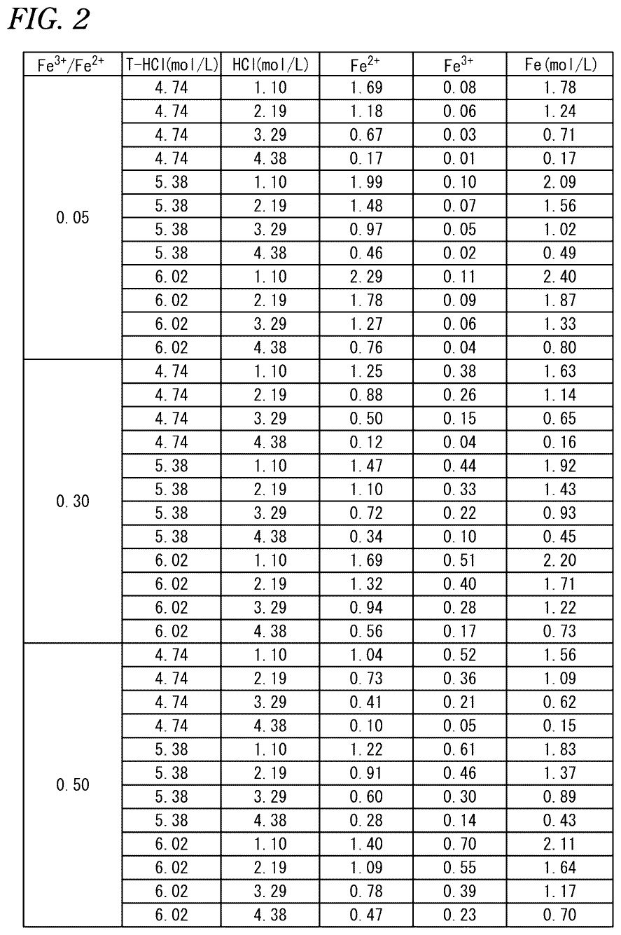

For confirming the accuracy of the above estimation equations, acidic solutions having various concentrations were prepared, and the concentrations of the total hydrochloric acid (T-HCl), the free hydrochloric acid (HCl), the Fe²⁺ ions, and the Fe³⁺ ions were actually measured (first measurement step). The actual measured values and the values calculated using the estimation equations were compared. FIG. 2 shows actual measured values of the prepared acidic solutions, and they were measured and detected by the titrimetric method. The concentrations of hydrochloric acid (HCL) in FIG. 2 are known quantities, and the others are unknown quantities.

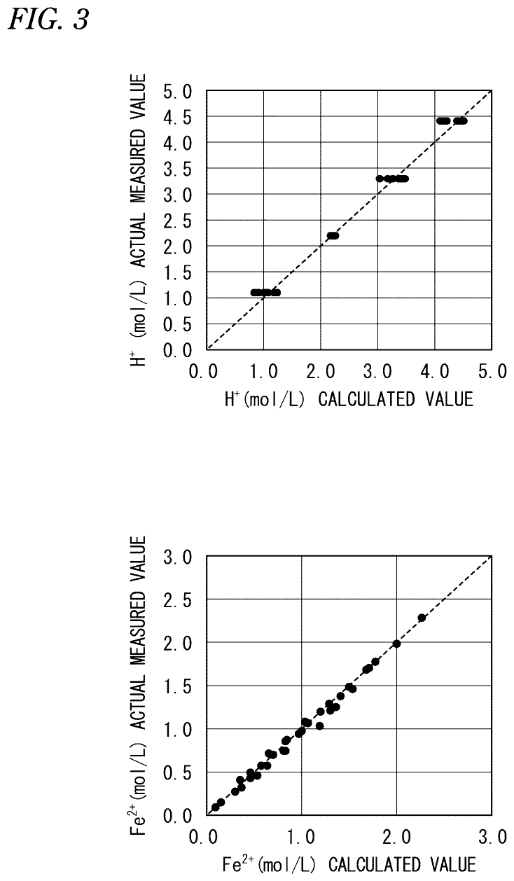

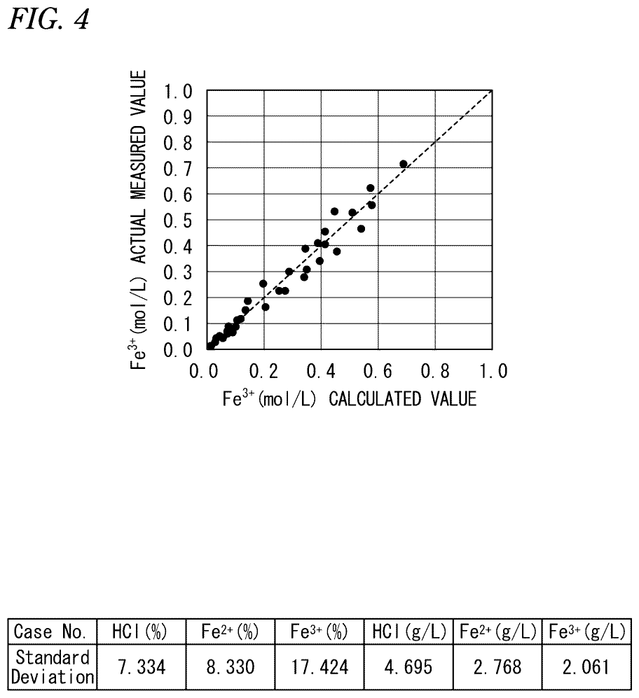

FIG. 3 and FIG. 4 show comparison results. It was confirmed that calculated values were close to actual measured values and the estimation equations constituted by equations (1) to (3) could be adopted for practical use.

Acidic solutions in which the concentrations of the Fe²⁺ ions and the Fe³⁺ ions were unknown were used. However, the accuracy of the estimation equations can be confirmed using acidic solutions in which the concentrations of the Fe²⁺ ions and the Fe³⁺ ions are known.

### [Relational Expression Construction Step (S103)]

Next, for the estimation equations constituted by equations (1) to (3), constants are determined and relational expressions are constructed. For the determination of constants, a multiple regression analysis is used. The constructed relational expressions are the same as the estimation equations in essence, and therefore, are referred to as relational expressions (1) to (3) unless the distinction between them is necessary.

For the estimation equation (1), [Fe²⁺] is adopted as an objective variable, EC, EC², d, d², and [H+] are adopted as explanatory variables, the multiple regression analysis is performed, and the constants are determined.

For the estimation equation (2), [Fe³⁺] is adopted as an objective variable, EC, EC², d, d², and [+] are adopted as explanatory variables, the multiple regression analysis is performed, and the constants are determined.

For the estimation equation (3), ORP is adopted as an objective variable, Ln [Fe²⁺], Ln [Fe³⁺], In [H+] are adopted as explanatory variables, the multiple regression analysis is performed, and the constants are determined.

In the case where the constants in the estimation equation (3) depend on the T-HCl, grouping is performed according to the T-HCl, and the constants in the estimation equation (3) are calculated for each included in the group. Thereafter, on an abscissa axis, the fitting of the correlation between the constants and the T-HCl is performed with a quadratic curve, and the dependence of the constants on the T-HCl is indicated.

In the examples in FIG. 2 to FIG. 4, specifically, groups that have 4.74 mol/L, 5.38 mol/L, and 6.02 mol/L as the concentration of the T-HCl are distinguished as a group 1, a group 2, and a group 3. The constants are calculated by the multiple regression analysis for the group 1 in which the concentration is 4.74 mol/L, the constants are calculated by the multiple regression analysis for the group 2 in which the concentration is 5.38 mol/L, and the constants are calculated by the multiple regression analysis for the group 3 in which the concentration is 6.02 mol/L. Thereafter, the dependence between the constants and the concentration of the T-HCl may be indicated by a quadratic curve.

### [Outline of Monitoring Step MN]

When relational expressions (1) to (3) are constructed by the above advance preparation step AP, the monitoring step MN can be executed. The monitoring step MN includes a step S201 of measuring the electrical conductivity EC, the specific gravity d and the ORP (oxidation-reduction potential) about the acidic solution with which the acid pickling is being performed and a step 203 of performing the computation of the concentrations by substituting the obtained actual measured value into the relational expression.

### [Measurement Step S201]

The electrical conductivity EC, the specific gravity d, and the ORP are measured by arbitrary measurement means (second measurement step).

For example, the electrical conductivity EC can be measured by an electrical conductivity meter using a known “alternating-current two-electrode method” or “electromagnetic induction method”. The alternating-current two-electrode method is a method of measuring the magnitude of electric current that flows between a pair of electrodes with a solution (acidic solution) therebetween. The electromagnetic induction method is a method of measuring the magnitude of induced electric current that is generated between a pair of coils that with a solution therebetween.

The specific gravity d can be measured by a known specific gravity meter such as a specific gravity meter using an aerometer or a specific gravity meter using a load cell.

The ORP, typically, can be measured by an oxidation-reduction potentiometer in which a potentiometer is connected between a platinum electrode and a comparison electrode.

### [Computation Step S203]

Once the electrical conductivity EC, the specific gravity d, and the ORP have been measured, they are substituted into the relational expressions (1) to (3), and the computation is performed.

First, the measured electrical conductivity EC and specific gravity d are substituted into equation (1) and equation (2). Correlation equation (4) of [Fe²⁺] and [H⁺] is obtained by equation (1), and correlation equation (5) of [Fe³⁺] and [H⁺] is obtained by equation (2).

$$[ {Fe}^{2 +} ] = A ⋆ EC + B ⋆ {EC}^{2} + C ⋆ d + D ⋆ {d}^{2} + E ⋆ [ {H}^{+} ] + F \qquad Equation ( 1 )$$

$$[ {Fe}^{3 +} ] = G ⋆ EC + H ⋆ {EC}^{2} + I * d + J ⋆ {d}^{2} + K ⋆ [ {H}^{+} ] + L \qquad Equation ( 2 )$$

$$[ {Fe}^{2 +} ] = r 1 * [ {H}^{+} ] \qquad Equation ( 3 )$$

$$[ {Fe}^{3 +} ] = r 2 * [ {H}^{+} ] \qquad Equation ( 4 )$$

After correlation equation (4) and correlation equation (5) are obtained, equation (4), equation (5), and the measured ORP are substituted into equation (3). Thereby, correlation equation (6) of the ORP and Ln [H⁺] is obtained.

$$ORP = M ⋆ Ln [ {Fe}^{2 +} ] + N ⋆ Ln [ {Fe}^{3 +} ] + O ⋆ Ln [ {H}^{+} ] + P \qquad Equation ( 3 )$$

$$ORP = Ln [ {H}^{+} ] \qquad Equation ( 6 )$$

In correlation equation (6), [H⁺] is determined by applying a calculation method of calculating back a value to be substituted for deriving a particular calculation result. From the acquired [H⁺], correlation equation (4), and correlation equation (5), [Fe²⁺] and [Fe³⁺] can be determined.

The above sequence of procedures shows that one or both of the concentrations of the Fe²⁺ ions and the Fe³⁺ ions can be determined based on correlation equation (4) of the hydrochloric acid concentration [H⁺] and the Fe²⁺ ion concentration [Fe²⁺] in the acidic solution, correlation equation (5) of the hydrochloric acid concentration [H⁺] and the Fe³⁺ ion concentration [Fe³⁺] in the acidic solution, and a relational expression (3) of the oxidation-reduction potential (ORP), the Fe²⁺ ion concentration [Fe²⁺], the Fe³⁺ ion concentration [Fe³⁺], and the hydrochloric acid concentration [H⁺] in the acidic solution.

[Fe²⁺] and [Fe³⁺] detected as described above are used for determining, by calculation, the additive amounts of elements of the acidic solution that are necessary for maintaining the performance of the acid pickling, for example, hydrochloric acid (HCL), hydrogen peroxide (H₂O₂), or the like (S205 in FIG. 1). Based on the additive amount obtained by calculation, hydrochloric acid (HCl), hydrogen peroxide (H₂O₂), or the like is added in the acidic solution. These additive agents are usually added in the form of a water solution. This addition can be performed by an operator that refers to the calculated value, or can be automatically performed by a feeder based on the calculated value.

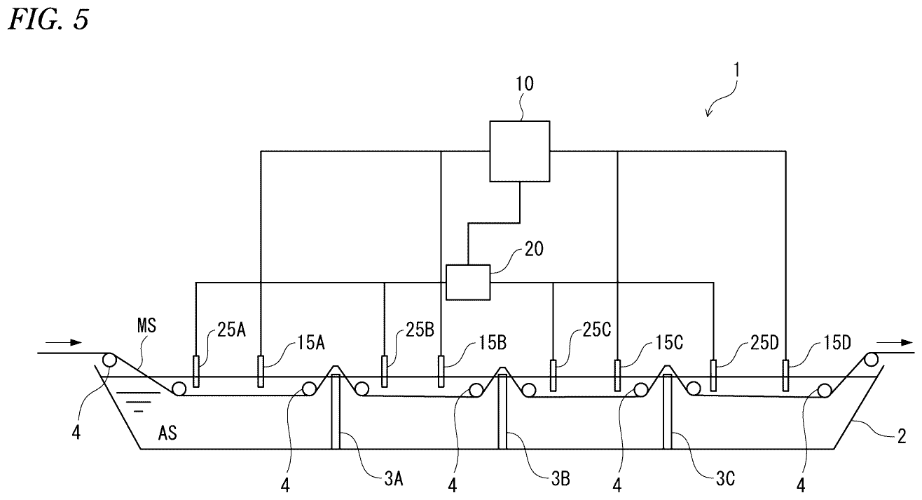

### [Acid Pickling Device: FIG. 5]

Next, an acid pickling device 1 that can carry out the concentration detection method according to the embodiment will be described with reference to FIG. 5.

The acid pickling device 1 detects [Fe²⁺] and [Fe³⁺] in an acidic solution AS online, while continuously performing the acid pickling of a long metal strip MS. The acid pickling device 1 automatically feeds the additive agent, for example, hydrochloric acid (HCL) or hydrogen peroxide (H₂O₂), to the acidic solution AS in an acid pickling tank 2, based on the detected [Fe²⁺] and [Fe³⁺ ].

The acid pickling device 1 includes the acid pickling tank 2 that stores the acidic solution AS, and a plurality of rollers 4 that support the metal strip MS such that the metal strip MS is immersed in the stored acidic solution AS is provided at proper places at intervals. As an example, the acid pickling tank 2 is divided into four regions by three partitions 3A, 3B, 3C.

The acid pickling device 1 includes a main-control part 10 and a sub-control part 20. The main-control part 10 and the sub-control part 20 are configured from computer devices.

The main-control part 10 detects [Fe²⁺] and [Fe³⁺] of the acidic solution AS, and calculates the amount of the additive agent to be added to the acidic solution, based on the detection result. The main-control part 10 transfers information relevant to the calculated amount of the additive agent, to the sub-control part 20.

For this, the main-control part 10 holds the above-described relational expressions (1) to (3), and executes the computation for obtaining the above-described correlation equations (4), (5). Further, the main-control part 10 obtains correlation equation (6) based on the obtained correlation equations (4), (5) and the relational expression (3). Furthermore, the main-control part 10 acquires [Fe²⁺] and [Fe³⁺] from correlation equation (6). Specific procedures at this time have been described above. The main-control part 10 corresponds to examples of the information acquisition part and the computation part in the present invention.

The sub-control part 20 feeds the additive agent to the acid pickling tank 2, based on the transferred information relevant to the amount of the additive agent.

The acid pickling device 1 includes measuring instrument units 15A, 15B, 15C, 15D as measurement parts that are immersed in the acidic solution AS in the respective regions of the acid pickling tank 2. Each of the measuring instrument units 15A, 15B, 15C, 15D includes at least an electrical conductivity meter, a specific gravity meter, and an oxidation-reduction potentiometer. The respective measuring instruments are immersed in the acidic solution AS, so as to perform the respective measurements. The respective measuring instrument units 15A, 15B, 15C, 15D are connected to the main-control part 10, and the main-control part 10 acquires information relevant to the electrical conductivity EC, the specific gravity d, and the oxidation-reduction potential ORP that are respectively measured. The information may be continuously acquired, or may be acquired at a predetermined time interval. After acquiring the electrical conductivity EC, the specific gravity d, and the oxidation-reduction potential ORP, the main-control part 10 executes the above-described procedures until the acquisition of [Fe²⁺] and [Fe³⁺] from correlation equation (6), in sequence.

The acid pickling device 1 includes feed nozzles 25A, 25B, 25C, 25D for feeding the additive agent to the respective regions of the acid pickling tank 2. In response to an instruction from the sub-control part 20, the additive agent is fed to the acidic solution AS stored in the acid pickling tank 2, from the feed nozzles 25A, 25B, 25C, 25D.

The actual measurement information that is relevant to [Fe²⁺] and [Fe³⁺] and that is acquired by the main-control part 10 is transferred to the sub-control part 20. The transfer of the actual measurement information may be continuously performed, or may be performed at a predetermined time interval.

The sub-control part 20 includes reference information relevant to [Fe²⁺] and [Fe³⁺] that are needed in the acidic solution AS. After receiving the transfer of the actual measurement information relevant to [Fe²⁺] and [Fe³⁺], the sub-control part 20 compares the reference information and the actual measurement information, and determines actual difference information. The sub-control part 20 holds reference difference information about this difference, compares the magnitudes of the actual difference information and the reference difference information, and determines that the feeding of the additive agent is necessary, when the actual difference information is larger than the reference difference information. The sub-control part 20 has also tanks that store various additive agents, and gives an instruction to feed a necessary additive agent from the feed nozzles 25A, 25B, 25C, 25D by a necessary amount.

### Effect

As described above, by the concentration detection method according to the embodiment, it is possible to detect [Fe²⁺] and [Fe³⁺] online, by constructing relational expressions (1) to (3) that are simultaneous equations with three variables.

The acid pickling device 1 to which this detection method is applied can detect [Fe²⁺] and [Fe³⁺] online, and in addition, automatically feeds the additive agent based on the detection result. Accordingly, the acid pickling device 1 can maintain the performance of the acid pickling with the acidic solution AS, without relying on human labor.

In the above-described embodiment, both of [Fe²⁺] and [Fe³⁺] are determined, but only one of [Fe²⁺] and [Fe³⁺] may be finally determined based on the above-described relational expressions (1) to (3).

Further, in the acid pickling device 1, the main-control part 10 and the sub-control part 20 are distinguished to be described, but an integrated control part may be adopted. Further, the example in which the measuring instrument unit (measurement part) and the feed nozzle (feed part) are provided in each of the divided regions of the acid pickling tank 2 in the acid pickling device 1 has been described, but a single measurement part and a single feed part may be provided in the acid pickling tank 2. In this case, the measurement part and the feed part may be provided so as to be close to each other, or may be provided so as to be away from each other.

### REFERENCE SIGNS LIST

1 acid pickling device
2 acid pickling tank
3A, 3B, 3C partition
4 roller
10 main-control part
15A, 15B, 15C, 15D measuring instrument unit
20 sub-control part
25A, 25B, 25C, 25D feed nozzle
As acidic solution
MS metal strip

1. A concentration detection method for one or both of Fe²⁺ ions and Fe³⁺ ions contained in an acidic solution for acid pickling of a rolled material, wherein
one or both of a Fe²⁺ ion concentration and a Fe³⁺ ion concentration are determined, based on
a relational expression (1) of the Fe²⁺ ion concentration that is a function of an electrical conductivity EC, a specific gravity d, and a hydrochloric acid concentration of the acidic solution,
a relational expression (2) of the Fe³⁺ ion concentration that is a function of the electrical conductivity EC, the specific gravity d, and the hydrochloric acid concentration of the acidic solution,
a relational expression (3) of an oxidation-reduction potential ORP that is a function of the Fe²⁺ ion concentration, the Fe³⁺ ion concentration, and the hydrochloric acid concentration of the acidic solution, and
the electrical conductivity EC, the specific gravity d, and the oxidation-reduction potential ORP of the acidic solution that are measured during the acid pickling.

2. The concentration detection method according to claim 1, wherein
the relational expression (3) of the oxidation-reduction potential ORP is expressed as a logarithmic leaner combination of the Fe²⁺ ion concentration, the Fe³⁺ ion concentration, and the hydrochloric acid concentration.

3. The concentration detection method according to claim 1, comprising:
a first measurement step of measuring the electrical conductivity EC, the specific gravity d, the oxidation-reduction potential ORP, the Fe²⁺ ion concentration, and the Fe³⁺ ion concentration, for each of a plurality of kinds of acidic solutions that contain the Fe²⁺ ions and the Fe³⁺ ions having unknown concentrations and that are different in the hydrochloric acid concentration; and
a relational expression construction step of specifying, by a multiple regression analysis,
the relational expression (1) that predicts the Fe²⁺ ion concentration, from the electrical conductivity EC and the specific gravity d that are measured in the first measurement step, and the hydrochloric acid concentration that is known,
the relational expression (2) that predicts the Fe³⁺ ion concentration, from the electrical conductivity EC and the specific gravity d that are measured in the first measurement step, and the hydrochloric acid concentration that is known, and
the relational expression (3) that predicts the oxidation-reduction potential ORP, from the Fe²⁺ ion concentration and the Fe³⁺ ion concentration that are measured in the first measurement step, and the hydrochloric acid concentration that is known.

4. The concentration detection method according to claim 3, comprising:
a second measurement step of measuring the electrical conductivity EC, the specific gravity d, and the oxidation-reduction potential ORP of the acidic solution during the acid pickling; and
a computation step of determining the Fe²⁺ ion concentration and the Fe³⁺ ion concentration, based on the electrical conductivity EC, the specific gravity d, and the oxidation-reduction potential ORP that are measured in the second measurement step, the relational expression (1), the relational expression (2), and the relational expression (3).

5. The concentration detection method according to claim 3, wherein
in the relational expression construction step,
an objective variable of the relational expression (1) is the Fe²⁺ ion concentration, explanatory variables include the electrical conductivity EC and the specific gravity d that are measured in the first measurement step, and the hydrochloric acid concentration that is known, and respective coefficients of the explanatory variables are determined,
an objective variable of the relational expression (2) is the Fe³⁺ ion concentration, explanatory variables include the electrical conductivity EC and the specific gravity d that are measured in the first measurement step, and the hydrochloric acid concentration that is known, and respective coefficients of the explanatory variables are determined, and
an objective variable of the relational expression (3) is the oxidation-reduction potential ORP, explanatory variables include logarithms of the Fe²⁺ ion concentration and the Fe³⁺ ion concentration that are measured in the first measurement step, and a logarithm of the hydrochloric acid concentration that is known, and respective coefficients of the explanatory variables are determined.

6. The concentration detection method according to claim 5, wherein
the coefficients of the explanatory variables of the relational expression (3) are determined such that the hydrochloric acid concentration in an acid pickling tank at time of start of the acid pickling is included.

7. A concentration detection device for Fe²⁺ ions and Fe³⁺ ions contained in an acidic solution for acid pickling of a rolled material, the concentration detection device comprising:
an information acquisition part configured to acquire information relevant to measurement values relevant to an electrical conductivity-meter, a specific gravity, and oxidation-reduction potential about the acidic solution; and
a computation part configured to determine one or both of a Fe²⁺ ion concentration and a Fe³⁺ ion concentration, based on the electrical conductivity, the specific gravity, and the oxidation-reduction potential that are acquired by the property information acquisition part.

8. The concentration detection device according to claim 7, comprising a measurement part including:
an electrical conductivity meter configured to measure the electrical conductivity of the acidic solution;
a specific gravity meter configured to measure the specific gravity of the acidic solution; and
an oxidation-reduction potentiometer configured to measure the oxidation-reduction potential of the acidic solution.

9. The concentration detection device according to claim 7, wherein
the computation part is configured to determine one or both of the Fe²⁺ ion concentration and the Fe³⁺ ion concentration, based on
a relational expression (1) of the Fe²⁺ ion concentration that is a function of an electrical conductivity EC, a specific gravity d, and a hydrochloric acid concentration of the acidic solution,
a relational expression (2) of the Fe³⁺ ion concentration that is a function of the electrical conductivity EC, the specific gravity d, and the hydrochloric acid concentration of the acidic solution,
a relational expression (3) of an oxidation-reduction potential ORP that is a function of the Fe²⁺ ion concentration, the Fe³⁺ ion concentration, and the hydrochloric acid concentration of the acidic solution, and
the electrical conductivity EC, the specific gravity d, and the oxidation-reduction potential ORP of the acidic solution that are measured during the acid pickling.
